(19) United States
(12) Patent Application Publication
(10) Pub. No.: US 2016/0123041 A1
(43) Pub. Date: May 5, 2016

(54) RECEIVER LOCK

(71) Applicant: Connor USA LLC, Oceanside, NY (US)

(72) Inventors: Shu Zhen CHEN, Westbury, NY (US); Henry CHEN, Westbury, NY (US)

(73) Assignee: CONNOR USA LLC

(21) Appl. No.: 14/529,871

(22) Filed: Oct. 31, 2014

(51) Int. Cl. E05B 67/36

(52) U.S. Cl. CPC E05B 67/36

(57) ABSTRACT

A receiver lock is provided. The receiver lock includes a lock rod having a distal portion configured to extend through aligned apertures of an insert and an accessory receiver to prevent removal of the insert from the accessory receiver. The distal portion includes an annular groove adjacent a distal end of the distal portion. A lock assembly is detachably mountable to the lock rod and includes a lock housing including a lock mechanism having a distal wall portion. The lock mechanism is rotatable relative to the lock housing from an unlocked configuration for receiving the distal end including the annular groove of the lock rod to a locked configuration for moving the distal wall portion of the lock mechanism into the received annular groove of the lock rod for locking the lock rod to the lock assembly thereby preventing withdrawal of the lock rod from the aligned apertures.

### BACKGROUND OF THE INVENTION

1. Field of the Invention

The present invention relates generally to a receiver lock, and more particularly, to a receiver lock that includes a lock assembly including a lock mechanism having a distal wall portion that is rotatable relative to a lock housing of the lock assembly for locking to a lock rod.

2. Description of the Related Art

Historically, hitches mounted to a towing vehicle included fixed components permanently secured to the vehicle. A hitch body was bolted or welded to the vehicle and included a hitch ball fixed to the hitch body. As hitch manufacturers developed more uses for their hitches, the fixed ball was replaced by a removable ball insert received within a receiver forming a part of the hitch body. Both the insert and receiver had a rectangular configuration such that the receiver would matingly receive the insert. To prevent inadvertent removal of the receiver, a lock rod (or pin) inserted transversely through the insert and receiver mated the components. The insert could be conveniently removed for interchange to a different insert associated with an accessory such as a cargo platform, bike carrier, ski rack, etc. However, this freedom to interchange accessories also lended them to theft since removal was as simple as removing a pin.

In order to prevent removal of the lock rod and therefore unauthorized removal of any hitch accessory, various locking methods were developed. A lock secured to the lock rod was first developed which prevented withdrawal of the lock rod without first removing the lock. These add-on locks proved cumbersome to use and were subjected to the elements of the road along with the rest of the undercarriage.

Specialized lock rods incorporating a locking mechanism were developed which allowed the user to replace the lock rod with a receiver lock. However, many of these receiver locks were inconvenient to use and subject to failure because of the intricate parts used for the locking mechanisms, e.g., locking mechanism including a biased ball bearing configuration configured to engage a lock rod and/or biased latches configured to engage the lock rod.

Therefore, there exists a need for a receiver lock that includes a lock assembly including a lock mechanism having a distal wall portion that is rotatable relative to a lock housing of the lock assembly for locking to a lock rod.

### SUMMARY OF THE INVENTION

The present invention has been made to address the above problems and disadvantages, and to provide at least the advantages described below.

In accordance with an aspect of the present invention, a receiver lock configured to lockingly connect an accessory insert within a receiver of a vehicle hitch assembly, the receiver and accessory insert including alignable apertures, is provided. The receiver lock includes a lock rod having a distal portion configured to extend through the aligned apertures of the insert and accessory receiver to prevent removal of the insert from the accessory receiver. The distal portion including an annular groove adjacent a distal end of the distal portion. A lock assembly is detachably mountable to the lock rod and includes a lock housing including a lock mechanism having a distal wall portion. The lock mechanism is rotatable relative to the lock housing from an unlocked configuration for receiving the distal end including the annular groove of the lock rod to a locked configuration for moving the distal wall portion of the lock mechanism into the received annular groove of the lock rod for locking the lock rod to the lock assembly thereby preventing withdrawal of the lock rod from the aligned apertures.

In accordance with another aspect of the present invention, a lock assembly configured to detachably mount to a lock rod configured to lockingly connect an accessory insert within a receiver of a vehicle hitch assembly, the receiver and accessory insert including alignable apertures, is provided. The lock assembly includes a lock housing including a lock mechanism having a distal wall portion. The lock mechanism is rotatable relative to the lock housing from an unlocked configuration for receiving a distal end including an annular groove of the lock rod to a locked configuration for moving the distal wall portion of the lock mechanism into the received annular groove of the lock rod for locking the lock rod to the lock assembly thereby preventing withdrawal of the lock rod from the aligned apertures.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a perspective view of a receiver lock including a lock assembly and a lock rod, which are shown unattached, according to an embodiment of the present invention;

FIG. 2 is a perspective view of the lock assembly shown in FIG. 1, with parts separated, according to an embodiment of the present invention;

FIG. 3 is a perspective view of a lock mechanism shown in FIG. 2, according to an embodiment of the present invention;

FIG. 4A is a rear-end view of the lock assembly with the lock assembly in an unlocked configuration, according to an embodiment of the present invention;

FIG. 4B is a partial cross-sectional view taken along line segment “4B-4B” of FIG. 1 with a portion of a lock housing of the lock assembly removed to illustrate the locking mechanism in the unlocked configuration, according to an embodiment of the present invention;

FIG. 5A is the same view as FIG. 4A except that the lock assembly is shown in a locked configuration, according to an embodiment of the present invention; and

FIG. 5B is the same view as FIG. 4B except that the lock mechanism is shown in the locked configuration, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

As used herein, the term “distal” refers to a portion of the receiver lock that is being described which is further from a user, while the term “proximal” refers to a portion of the receiver lock that is being described which is closer to a user.

As noted above, there exists a need for a receiver lock that includes a lock assembly including a lock mechanism having a distal wall portion that is rotatable relative to a lock housing of the lock assembly for locking to a lock rod, and such a receiver lock is described herein.

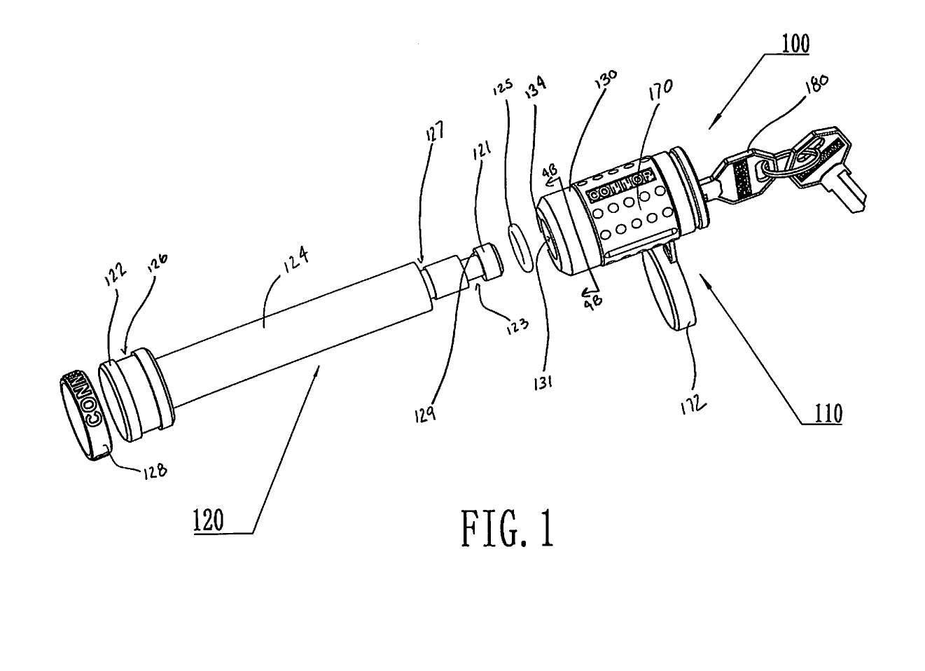

FIG. 1 is a perspective view of a receiver lock 100 including a lock assembly 110 and lock rod 120, which are shown separated, according to an embodiment of the present invention. The receiver lock 100 is configured to connect an accessory insert (not shown) within a receiver of a vehicle hitch assembly (also not shown). The receiver and accessory insert include apertures that are alignable when the accessory insert is positioned within the receiver.

The lock rod 120 is circular in cross section and has a generally elongated configuration. The lock rod 120 includes a proximal portion 122 and a distal portion 124. The proximal portion 122 has a diameter that is larger than a diameter of the distal portion 124. The distal portion 124 has a length and diameter that is configured to allow a user to insert the distal portion 124 through the aligned apertures of the accessory insert and the receiver, while the diameter of the proximal portion 122 is configured to prevent the proximal portion 122 from passing through the aligned apertures of the accessory insert and the receiver.

The proximal portion 122 includes an annular recess 126 which has seated therein a rubber gripping surface 128 that is configured to facilitate gripping of the proximal portion 122. Alternatively, the proximal portion 122 can be provided without the rubber gripping surface 128, in which case the annular recess 126 can be omitted.

The distal portion 124 includes a distal end 121 and an annular groove 123 that is positioned adjacent the distal end 121. The distal end 121 and annular groove 123 are insertable into the lock assembly 120, as will be described below.

An O-ring 125 of suitable configuration is seated within an annular recess 127, which is provided proximal to the annular groove 123, and is configured to form a seal between the lock rod 120 and the lock assembly 110 when the lock rod 120 and lock assembly 110 are in a locked configuration, as will be described below. Alternatively, the O-ring 125 can be replaced by a gasket or other suitable structure, or distal portion 124 may be provided without the O-ring 125.

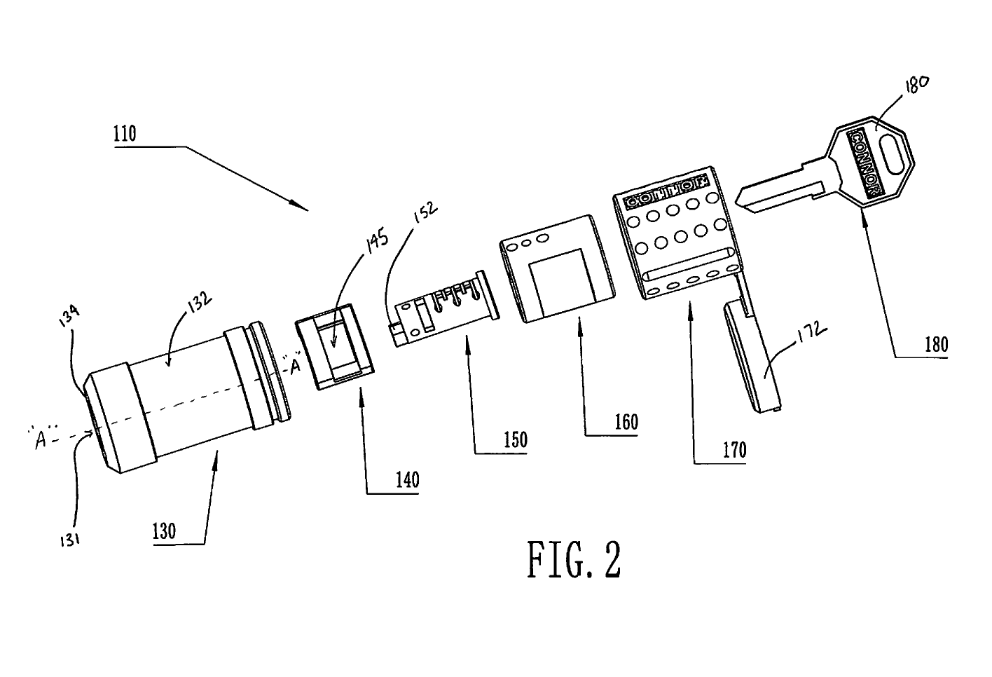

FIG. 2 is a perspective view of the lock assembly 110 shown in FIG. 1, with parts separated, according to an embodiment of the present invention. As illustrated in FIG. 2, the lock assembly 110 includes a lock housing 130, a lock mechanism 140, a cylinder 150, a cylinder receiver 160, a gripping surface 170, and at least one key 180.

The lock housing 130 houses the internal components of the lock assembly 110. The lock housing 130 is coupled, via one or more suitable coupling methods, to the cylinder receiver 160 which is connected by suitable methods to the cylinder 150. In the assembled configuration, the cylinder 150 is rotatable with respect to both the lock housing 130 and the cylinder receiver 160 when the key 180 is inserted into the cylinder 150 and turned, e.g., for locking and unlocking the lock rod 120 to and from the lock assembly 110.

As the cylinder 150 and the cylinder receiver 160 are known in the art, a detailed description of these components is omitted for brevity.

The lock housing 130 includes an opening 131 (as best seen in FIG. 1) of suitable configuration that is configured to receive the distal end 121 including the annular groove 123 of the lock rod 120. The lock housing 130 also includes an annular recess 132 that has positioned therein the gripping surface 170 that is configured to facilitate gripping of the lock housing 130.

An optional cap 172 may be tethered to the gripping surface 170 and may be used to cover a proximal end of the lock housing 130 including the cylinder 150 when the key 180 is not inserted in cylinder 150 to protect the internal components of the lock housing 130. Moreover, while not shown in the drawings, an optional cap may be tethered to the gripping surface 170 to cover the opening 131 of the lock housing 130, such as when the lock rod 130 and lock assembly 120 are unattached to one another.

FIG. 3 is a perspective view of the lock mechanism 140, according to an embodiment of the present invention. The lock mechanism 140 includes at its proximal end 142 a recess 144 that is configured to engage a corresponding post or nub 152 (FIG. 2) of the cylinder 150 for coupling the lock mechanism 140 to the cylinder 150, which allows the lock mechanism 140 and the cylinder 150 to rotate in unison. Soldering, brazing, or welding can be used to join the post 152 of the cylinder 150 to the recess 144. Alternatively, the lock mechanism 140 and the cylinder 150 can be formed as a single component.

The lock mechanism 140 includes a generally elliptical configuration and has a distal wall portion 146. The distal wall portion 146 extends distally from the proximal end 142 at a distance that allows at least a portion of the distal wall portion 146 to be received within the annular groove 123 of the lock rod 130 when the annular groove 123 is inserted into the lock housing 130 and the lock mechanism 140 is rotated to the locked configuration, as described below.

The distal wall portion 146 has a crescent-like shape and has at least partially defined therethrough a notch 145 (FIGS. 2 and 3) that is configured to receive the distal end 121 of the lock rod 120 when the distal end 121 including the annular groove 123 of the lock rod 120 are inserted into the lock housing 130 of the lock assembly 110 and the lock mechanism 140 is rotated to the locked configuration, as described below.

The distal wall portion 146 extends substantially along a circumference of proximal end 142 of the lock mechanism 140 and moves along an elliptical axis of rotation when the lock mechanism 140 is moved from the unlocked configuration to the locked configuration. As the distal wall portion 146 is moved along the elliptical axis of rotation, a center portion 148 (shown by phantom lines in FIG. 3), which is defined between points 147a, 147b, of the distal wall portion 146 is moved into the received annular groove 123 of the lock rod 120 and into contact with a distal wall 129 (FIG. 1) that partially defines the annular groove 123 of the lock rod 120. Moreover, as the distal wall portion 146 moves along the elliptical axis of rotation, the distal end 121 of the lock rod is received into the notch 145 of the distal wall portion 146.

It is noted that the contact between the center portion 148 of the distal wall portion 146 and the distal wall 129 of the lock rod 120 facilitates in maintaining the lock rod 120 and the lock assembly 110 in a tightly locked configuration. It also facilitates in pressing the O-ring 125 against a corresponding depression 134 (FIG. 1) defined at a distal end of lock housing 130, thereby forming a tight seal between the lock rod 120 and the lock assembly 110 when these components are in the locked configuration.

It is noted that, other than the gripping surfaces 128, 170 and the O-ring 125, all other components of the receiver lock 100 may be manufactured from metal, metal alloys, and the like. However, in embodiments, other materials may also be used to form the components of the receiver lock 100.

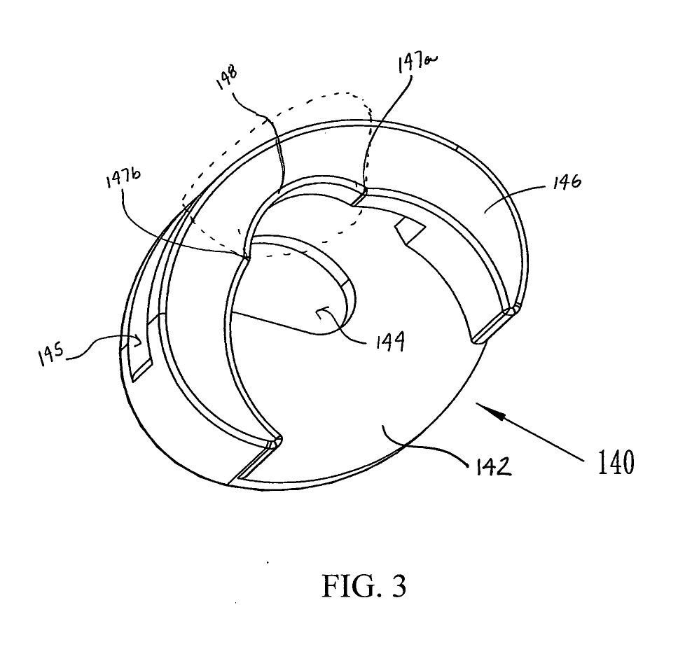

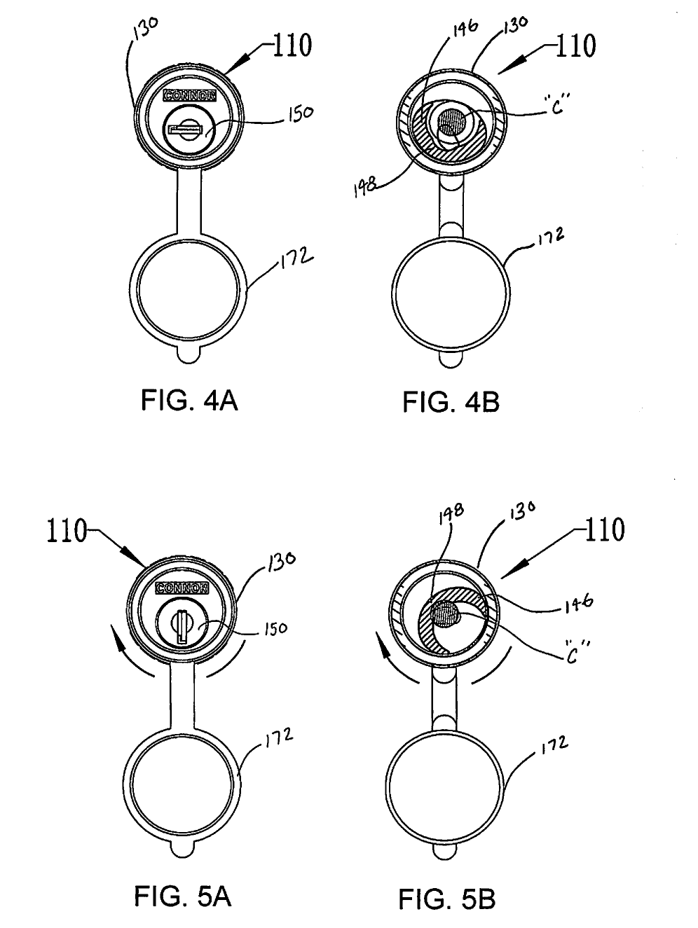

In use, a user inserts the distal portion 124 through the aligned apertures of the accessory insert and the receiver of the vehicle hitch assembly. Thereafter, in the unlocked configuration (FIGS. 4A and 4B), the user mounts the lock assembly 110 to the lock rod 120 by inserting the distal end 121 including the annular groove 123 into the opening 131 of the lock housing 130. In the unlocked configuration, the distal wall portion 146 will be positioned within the lock housing 130 below the opening 131 of the lock housing 130, which allows a user to insert the distal end 121 including the annular groove 123 into the opening 131. In FIG. 4B a distal face of the lock housing 130 is removed to show the position and relative movement of the distal wall portion 146 of the lock mechanism 140 with respect to the lock housing 130. An imaginary center point “C” of the opening is provided in FIG. 4B as a reference point. It is noted that the distal end 121 including the annular groove 123 will be positioned approximately in-line with the center point “C” when these components are inserted through the opening 131 of the lock housing 130. Thus, when the lock mechanism 140 is rotated, it will move along an elliptical axis of rotation about a longitudinal axis “A-A” (FIG. 2) of the lock assembly 110 (and the lock rod 120 when the lock rod 120 is inserted into the opening 131 of the lock housing 130) that extends through the center point “C.” In embodiments, however, it may prove advantageous for the lock mechanism 140 to rotate along a circular axis.

Once the distal end 121 including the annular groove 123 is inserted into the opening 131 of the lock housing 130, a user can insert the key 180 into the cylinder 150 and turn the key 180 in clockwise motion (or counterclockwise motion in certain embodiments), as indicated by the directional arrow of FIG. 5A. Turning the key 180 in clockwise motion moves the distal wall portion 146 including the center portion 148 of the lock mechanism 140 along the elliptical axis of rotation and into the received annular groove 123 of the lock rod 120 and moves the distal end 121 of the lock rod 120 into the notch 145 of the lock mechanism 140 thereby locking the lock rod 120 to the lock assembly 110 and preventing withdrawal of the lock rod 120 from the aligned apertures.

The receiver lock 100 including the lock assembly 110 and lock rod 120 overcomes the aforementioned drawbacks that are associated with conventional receiver locks. That is, the receiver lock 100 provides a quick and easy method of locking the lock rod 120 to the lock assembly 110, without using the intricate components that are typically associated with conventional receiver locks.

From the foregoing and with reference to the various figure drawings, those skilled in the art will appreciate that certain modifications can also be made to the present invention without departing from the scope of the same. For example, while it has been described herein that the center portion 148 of the distal wall portion 146 is received within the annular groove 123, other portions of the distal wall portion 146 may also be received within the annular groove 123. For example, the lock mechanism 146 may be configured such that the portions that extend outside the boundary defined by points 147a and 147b are received within the annular groove 123 of the lock rod 120.

Moreover, while the lock mechanism 146 has been described herein as moving along an elliptical path of rotation, the present invention is not so limited. For example, in embodiments that lock mechanism 146 may have other geometrical configurations including, but not limited, to circular, square, rectangular, triangular, etc. In such embodiments, the lock mechanism 146 will move along a corresponding axis of rotation, e.g., a lock mechanism having a circular configuration will move along a circular axis of rotation.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

1. A receiver lock configured to lockingly connect an accessory insert within a receiver of a vehicle hitch assembly, the receiver and accessory insert including alignable apertures, the receiver lock comprising:
a lock rod having a distal portion configured to extend through the aligned apertures of the insert and accessory receiver to prevent removal of the insert from the accessory receiver, the distal portion including an annular groove adjacent a distal end of the distal portion; and
a lock assembly detachably mountable to the lock rod, the lock assembly including a lock housing including a lock mechanism having a distal wall portion that extends from a proximal end of the lock mechanism,
wherein the lock mechanism is rotatable relative to the lock housing from an unlocked configuration for receiving the distal end including the annular groove of the lock rod to a locked configuration for moving the distal wall portion of the lock mechanism into the received annular groove of the lock rod for locking the lock rod to the lock assembly thereby preventing withdrawal of the lock rod from the aligned apertures, and
wherein, in the locked configuration, the distal end of the lock rod does not extend distally past the proximal end of the lock mechanism.

2. The receiver lock according to claim 1, wherein the distal wall portion of the lock mechanism includes a notch that is configured to receive the distal end of the lock rod when the lock mechanism is moved into the locked configuration.

3. The receiver lock according to claim 1, wherein the lock mechanism includes a generally elliptical configuration.

4. The receiver lock according to claim 3, wherein the distal wall portion extends substantially along a circumference of the lock mechanism and moves along an elliptical axis of rotation when the lock mechanism is moved from the unlocked configuration to the locked configuration such that a center portion of the distal wall portion is moved into the received annular groove of the lock rod and into contact with a distal wall that partially defines the annular groove of the lock rod.

5. The receiver lock according to claim 1, wherein in the locked configuration the lock rod and the lock assembly are rotatable relative to one another.

6. The receiver lock according to claim 1, wherein the lock mechanism is operable with a key of the lock assembly.

7. A lock assembly configured to detachably mount to a lock rod configured to lockingly connect an accessory insert within a receiver of a vehicle hitch assembly, the receiver and accessory insert including alignable apertures, the lock assembly comprising:
a lock housing including a lock mechanism having a distal wall portion that extends from a proximal end of the lock mechanism,
wherein the lock mechanism is rotatable relative to the lock housing from an unlocked configuration for receiving a distal end including an annular groove of the lock rod to a locked configuration for moving the distal wall portion of the lock mechanism into the received annular groove of the lock rod for locking the lock rod to the lock assembly thereby preventing withdrawal of the lock rod from the aligned apertures, and
wherein, in the locked configuration, the distal end of the lock rod does not extend distally past proximal end of the lock mechanism.

8. The lock assembly according to claim 7, wherein the distal wall portion of the lock mechanism includes a notch that is configured to receive the distal end of the lock rod when the lock mechanism is moved into the locked configuration.

9. The lock assembly according to claim 7, wherein the lock mechanism includes a generally elliptical configuration.

10. The lock assembly according to claim 9, wherein the distal wall portion extends substantially along a circumference of the lock mechanism and moves along an elliptical axis of rotation when the lock mechanism is moved from the unlocked configuration to the locked configuration such that a center portion of the distal wall portion is moved into the received annular groove of the lock rod and into contact with a distal wall that partially defines the annular groove of the lock rod.

11. The lock assembly according to claim 7, wherein in the locked configuration the lock rod and the lock assembly are rotatable relative to one another.

12. The lock assembly according to claim 7, wherein the lock mechanism is operable with a key of the lock assembly.
